(19) United States
(12) Patent Application Publication
(10) Pub. No.: US 2011/0016398 A1
(43) Pub. Date: Jan. 20, 2011

(54) Slide Show

(76) Inventor: David H. Hanes, Loveland, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/504,299

(22) Filed: Jul. 16, 2009

(51) Int. Cl. G06F 3/00

(52) U.S. Cl. 715/730

(57) ABSTRACT

A method for displaying images of interest as a slide show including scanning metadata of images to identify the images which match one or more criteria, classifying the images which have metadata that match one or more of the criteria as the images of interest, and displaying the slide show of the images of interest on a display device.

### BACKGROUND

When creating a slide show, a machine scans a storage device for one or more images. Once the machine has found one or more images on the storage device, the machine creates the slide show and includes the images found on the storage device in the slide show. The machine then configures a display device to display the slide show.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the embodiments.

FIG. 1 illustrates a machine coupled to a digital display device and a memory/storage device which stores a slide show application and one or more images according to an embodiment of the invention.

FIG. 2 illustrates a block diagram of a slide show application analyzing metadata of images to identify images of interest according to an embodiment of the invention.

FIG. 3 illustrates a block diagram of a slide show application creating one or more slide shows based on one or more criteria according to an embodiment of the invention.

FIG. 4 illustrates a machine with an embedded slide show application and a slide show application stored on a removable medium being accessed by the machine according to an embodiment of the invention.

FIG. 5 is a flow chart illustrating a method for displaying images of interest as a slide show according to an embodiment of the invention.

FIG. 6 is a flow chart illustrating a method for displaying images of interest as a slide show according to another embodiment of the invention.

### DETAILED DESCRIPTION

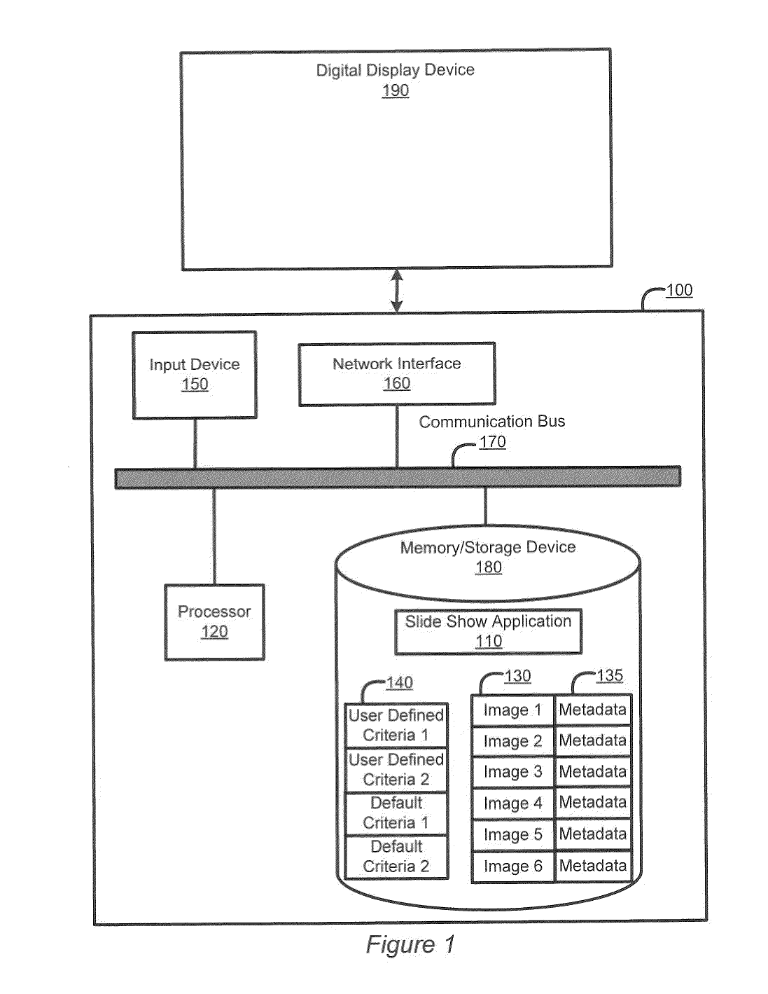

FIG. 1 illustrates a machine 100 coupled to a digital display device 190 and a memory/storage device 180 which stores a slide show application 110 and one or more images 130 according to an embodiment of the invention. In one embodiment, the machine 100 is a digital photo frame. In other embodiments, the machine 100 is a desktop, a laptop, a server, and/or any device that a digital display device 190 is coupled to. As illustrated in FIG. 1, the machine 100 is coupled to the digital display device 190 and includes a processor 120, one or more input devices 150, a memory/storage device 180, a network interface 160, and a communication bus 170 for the machine 100 and/or one or more components of the machine 100 to communicate with one another.

Further, as illustrated in FIG. 1, the memory/storage device 180 stores a slide show application 110, one or more images 130, metadata for the images 135, and one or more criteria 140. In other embodiments, the machine 100 includes additional components and/or is coupled to additional components in addition to and/or in lieu of those noted above and illustrated in FIG. 1

As noted above, the machine 100 includes a processor 120. The processor 120 sends data and/or instructions to the components of the machine 100, such as one or more input devices 150, the memory/storage device 180, the digital display device 190, and the slide show application 110. Additionally, the processor 120 receives data and/or instruction from components of the machine 100, such as the slide show application 110.

The slide show application 110 creates one or more slide shows for display on the digital display device 190 based on one or more criteria 140. A slide show includes one or more images 130 that have been classified as images of interest. One or more images 130 are digital images which are stored locally or remotely on the memory/storage device 180. Additionally, one or more images 130 include corresponding metadata 135 which specify details of the corresponding image 130. In other embodiments, the machine 100 is coupled to additional storage devices which are configured to store one or more images 130 and can be accessed and/or stored locally or remotely.

The digital display device 190 is a device that can be configured by the slide show application 110 to display, and/or project one or more slides shows. In one embodiment, the digital display device 190 is a monitor and/or television. In another embodiment, the digital display device 190 is a projector and/or a touch screen. In other embodiments, the machine 100 is coupled to one or more additional display devices that can be configured to display the slide show and/or any additional slide shows based upon one or more of the criteria 140 and/or one or more additional criteria.

The slide show application 110 is an application that creates and manages one or more slide shows for the machine 100. The slide show application 110 initially identifies one or more criteria 140 to be used for a slide show. The slide show application 110 then scans metadata of one or more images 130 based on one or more of the criteria 140 to identify which of the images 130 have metadata that match one or more of the criteria 140. Additionally, the slide show application classifies the images 130 whose metadata match the criteria as images of interest. The slide show application 110 then includes the images 130 classified as images of interest in the slide show for display on the digital display device 190 or an additional digital display device.

In one embodiment, the slide show application 110 is firmware that is embedded onto the machine 100. In other embodiments, the slide show application 110 is a software application stored on the machine 100 within ROM or on the memory/storage device 180 accessible by the machine 100 or the slide show application 110 is stored on a computer readable medium, readable and accessible by the machine 100 from a different location. Additionally, in one embodiment, the memory/storage device 180 is included in the machine 100. In other embodiments, the storage device 180 is not included in the machine 100, but is remotely accessible to the machine 100 utilizing a network interface 160 included in the machine 100. The network interface 160 may be a wired or wireless network interface card.

In a further embodiment, the slide show application 110 is stored and/or accessed through a server coupled through a local area network or a wide area network. The slide show application 110 communicates with devices and/or components coupled to the machine 100 physically or wirelessly through a communication bus 170 included in or attached to the machine 100. In one embodiment the communication bus 170 is a memory bus. In other embodiments, the communication bus 170 is a data bus.

As noted above, in creating a slide show, the slide show application 110 initially identifies one or more criteria 140 to be used for the slide show. One or more of the criteria 140 specify rules for the slide show. Additionally, one or more of the criteria specify and determine what types of images can be included in the slide show. As a result, one or more of the criteria 140 determine whether one or more of the images 130 will be classified as an image of interest and whether one or more of the images 130 will be included as part of the slide show.

In one embodiment, one or more of the criteria 140 can specify that the slide show includes images 130 which were created on or near a specified date and/or images 130 created at or near a specified time. For the purposes of this application, an image is created when the image is captured with an image capture device or when the image is scanned and/or stored onto the machine 100. As a result, a date and/or time of creation of an image can correspond to when the image was captured by an image capture device or when the image was scanned and/or stored onto the machine 100. The image can be scanned and/or stored onto the machine 100 automatically by the machine 100 or manually by the user utilizing a scanner or any other image scanning device.

Additionally, one or more of the criteria 140 can specify that the slide show includes images 130 created at or near a specified location. For the purposes of this application, a creation location for an image corresponds to where the corresponding image was captured or where the corresponding image was scanned and/or stored onto the machine 100. Further, one or more of the criteria 140 can specify that the slide show includes images 130 of one or more specified persons. In Addition, one or more of the criteria 140 can specify that the slide show includes images 130 which do not have any people in them. In other embodiments, one or more of the criteria 140 can specify additional rules for the slide show.

As noted above, in one embodiment, one or more of the criteria 140 specify that the slide show includes images created on or around a specified date. As a result, the slide show application 110 will classify images 130 created on the specified date as images of interest. In another embodiment, the slide show application 110 can also use a previously defined buffer of plus or minus X days from the date specified to allow images 130 created around the specified date to also be classified as images of interest. The previously defined buffer can be defined manually by a user or automatically by the slide show application 110.

Additionally, similar to above, a previous defined buffer can also be used by the slide show application 110 in classifying images of interest when one or more of the criteria specify that the slide show includes images created at or around a specified time or at or around a specified location. As a result, images 130 created around the specified time and/or images created around the specified location can also be classified as images of interest.

Additionally, one or more of the criteria 140 can be used individually or in conjunction with one another. Further, one or more of the criteria 140 can be previously defined or created upon request. One or more of the criteria 140 can be manually defined by a user or automatically by the machine 100. In one embodiment, one or more of the criteria 140 are default criteria provided by a manufacturer or downloaded from a website.

In choosing which of the criteria 140 to be used for the slide show, the user can manually select one or more of the criteria 140 from a list of criteria displayed on the digital display device 190. The user can access an input device 150 and/or the digital display device 190 directly in selecting one or more of the criteria 140 from the list of criteria. The input device 150 is any device that the user can access when choosing one or more of the criteria 140 for the slide show. In one embodiment, the input device 150 is a remote and includes one or more buttons and/or one or more directional pads. In another embodiment, the input device 150 is a mouse and/or a keyboard.

Additionally, as noted above, in one embodiment, the digital display device 190 is a touch screen. As a result, a user can access the digital display device 190 directly by touching a screen of the digital display device 190 when choosing one or more of the criteria 140 to be used for the slide show. When the slide show application 110 detects input from the input device 150 and/or the digital display device 190, the slide show application 110 can process the choices made by the user in selecting one or more of the criteria 140. In other embodiments, the slide show application 110 can automatically and/or randomly choose one or more of the previously defined criteria 140 for the slide show.

Once the slide show application 110 has identified one or more of the criteria 140 to be used for the slide show, the slide show application 110 will proceed to scan the metadata 135 of all of the images 130 to identify which of the images 130 have metadata 135 that match one or more of the identified criteria 140. As noted above, all of the images 130 include corresponding metadata 135. Additionally, as noted above, the metadata 135 specify details of the corresponding image 130. Further, the metadata 135 can be embedded into the images 130 or the metadata 135 can be stored as separate files and can be associated with the images 130. In other embodiments, the metadata 135 can be defined and/or edited by a user and/or the machine 100.

In one embodiment, the metadata 135 specify at least one from the group consisting of at what time the corresponding image was created, on what date the corresponding image was created, at what GPS coordinate (location) was the corresponding image created, whether the corresponding image includes any people, and/or who is included in the corresponding image. In other embodiments, the metadata 135 specify additional details of the corresponding images 130 in addition to and/or in lieu of those noted above.

As noted above, an image is created when the image is captured with an image capture device or when the image is scanned and/or stored onto the machine 100. As a result, the time and/or date of creation listed in the metadata 135 can correspond to when the image was captured or when the corresponding image was scanned and/or stored onto the machine 100. Additionally, a creation location for an image corresponds to where the corresponding image was captured or where the corresponding image was scanned and/or stored onto the machine 100. As a result, the GPS coordinate listed in the metadata 135 can correspond to where the image was captured or where the image was scanned and/or stored onto the machine 100.

The slide show application 110 will scan the metadata 135 of all of the images 130 based on one of more of the identified criteria 140 to identify which of the images 130 have a matching date, time, location, person, and/or whether the corresponding image have any people in it. In one embodiment, if one or more of the identified criteria 140 specify that the slide show includes images created on or around a specified date, the slide show application 110 will scan the metadata 135 of all of the images 130 to identify what date all of the images 130 were created.

As noted above, in one embodiment, the user or the slide show application 110 can define a buffer of plus or minus X days to include images created around the specified date as images of interest. As a result, the slide show application 110 can proceed to classify images whose metadata list that the corresponding image was created on the specified date or plus or minus X days from the specified date as images of interest.

In another embodiment, if one or more of the identified criteria 140 specify that the slide show includes images of one or more persons, the slide show application 110 can utilize facial recognition technology in conjunction with scanning the metadata 135 in determining whether one or more persons are included in any of the images 130. In other embodiments, if one or more of the identified criteria 140 specify that the slide show includes images which do not include any people, the slide show application 110 can additionally use face detection technology in conjunction with scanning the metadata 135 in determining whether the images 130 include any people in them.

Once the slide show application 110 has classified all of the images of interest, the slide show application 110 will proceed to create a slide show which includes the images which have been classified as images of interest. The slide show application 110 will then display the slide show on the digital display device 190 and/or any additional digital display devices. In one embodiment, the slide show application 110 can additionally create additional slide shows for display on the digital display device 190 and/or the additional digital display devices coupled to the machine 100. The additional slide shows can be based on one or more criteria 140 which are different from the criteria used for the slide show.

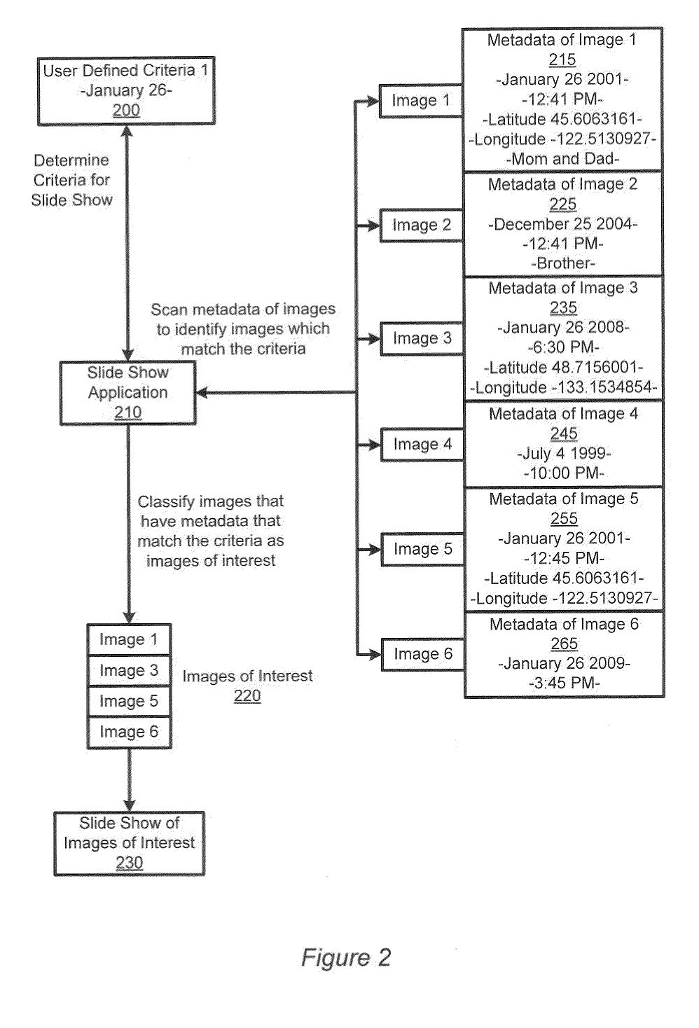

FIG. 2 illustrates a block diagram of a slide show application 210 analyzing metadata of images to identify images of interest 220 according to an embodiment of the invention. As noted above, the images have corresponding metadata. Further, as illustrated in FIG. 2, the metadata specify at least one from the group consisting of on what date the corresponding image was created, at what time the corresponding image was created, at what GPS coordinate (location) the corresponding image was created, who is included in the corresponding image, and whether the corresponding image includes any people.

As noted above, when identifying images of interest, the slide show application 210 will initially identify one or more criteria 200 to be used for the slide show 230. In one embodiment, as illustrated in FIG. 2, a user defined criteria 1 200 is chosen to be used by the slide show application 210 for the slide show 230. The user defined criteria 1 200 illustrated in FIG. 2 specifies that the slide show 230 includes images created on “January 26.”

As a result, the slide show application 210 will scan the metadata of images 1, 2, 3, 4, 5, and 6 to determine which of the images were created on “January 26” and can be classified as images of interest to be included in the slide show 230. In the present embodiment, the slide show application 210 will initially scan the metadata of image 1 215 and determine that image 1 has a matching creation date as the date specified from the user defined criteria 200. As a result, image 1 can be classified as an image of interest 220 and will be included in the slide show 230.

Additionally, the slide show application 210 will next scan the metadata of image 2 225 and determine that image 2 does not have a matching creation date, since image 2 was created on December 25. As a result, the slide show application 210 will determine that image 2 will not be classified as an image of interest 220 and will not be included in the slide show 230. The slide show application 210 will then scan the metadata of image 3 235 and determine that image 3 also has a matching creation date of January 26. As a result, the slide show application 210 will determine that image 3 will also be classified as an image of interest 220 and will be included with image 1 in the slide show 230.

Further, the slide show application 210 will additionally scan the metadata of image 4 245, the metadata of image 5 255, and the metadata of image 6 265 to determine whether any of the images were created on January 26. As illustrated in FIG. 2, the metadata of image 4 shows that the creation date of image 4 is July 4, as a result, the creation date does not match the user defined criteria 1 200. However, the slide show application 210 scans the metadata of image 5 255 and the metadata of image 6 265 and determines that image 5 and image 6 have creation dates of January 26. As a result, the slide show application 210 will proceed to classify images 5 and 6 as images of interest 220.

As illustrated in FIG. 2, images 1, 3, 5, and 6 have been classified as images of interest 220 and the images of interest 220 are used for the slide show 230. In other embodiments, the user defined criteria 1 200 can specify that the slide show 230 includes images created on or around “January 26.” As a result, the slide show application 210 can utilize a predefined buffer to additionally classify images which were created within a predefined buffer from “January 26” as images of interest 220. As shown with the above embodiment, the slide show application 210 can scan the metadata of all of the images sequentially. In other embodiments, the slide show application 210 can scan the metadata of all of the images concurrently.

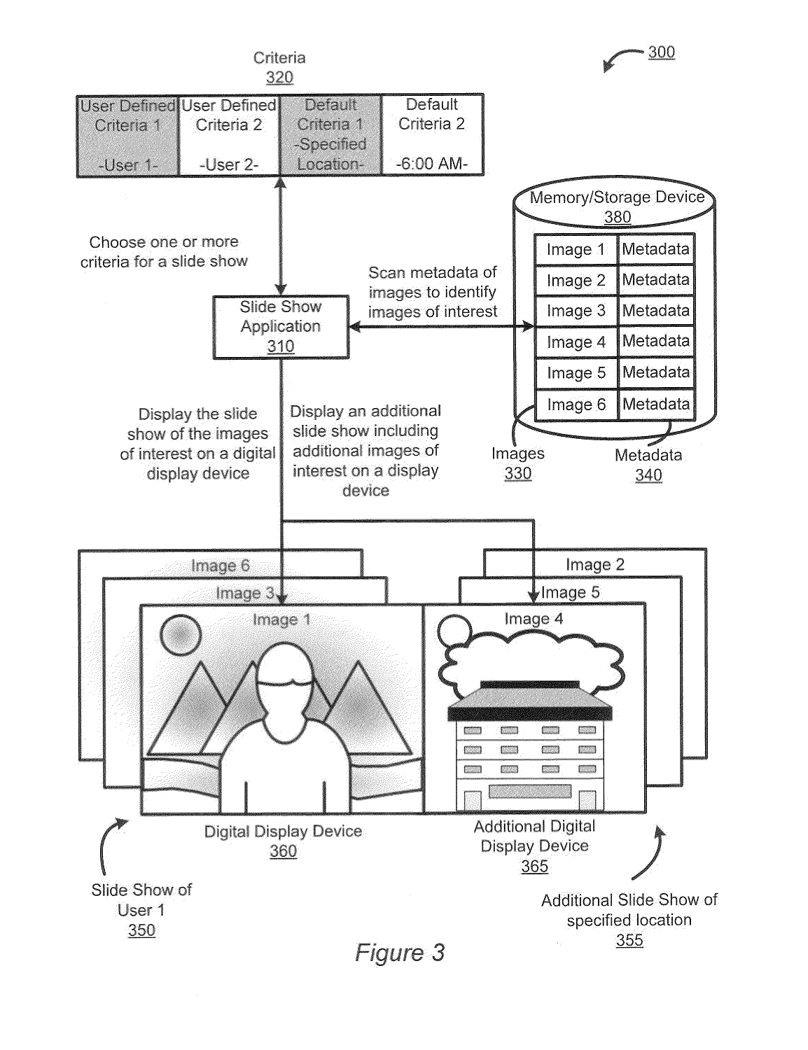

FIG. 3 illustrates a block diagram of a slide show application 310 creating slide shows 350, 355 based on one or more criteria 320 according to an embodiment of the invention. As noted above, in one embodiment, the slide show application 310 is stored on a machine 300. Additionally, as noted above, the machine 300 may include both a digital display device 360 and an additional display device 365. Both the digital display device 360 and the additional digital display device 365 can be configured by the slide show application 310 to display one or more slide shows. In one embodiment, the slide show application 310 creates the slide show 350 and the additional slide show 355 concurrently.

Further, as noted above, one or more slide shows 350, 355 are created based on one or more criteria 320. As illustrated in FIG. 3, in one embodiment, the machine 100 includes four predefined criteria 320, two user defined criteria and two default criteria The slide show application 310 will initially choose one or more of the criteria 320 for one or more of the slide shows 350, 355. In the present embodiment, the slide show application 310 will choose user defined criteria 1 for a slide show 350 to be displayed on the digital display device 360. As illustrated in FIG. 3, the user defined criteria 1 specifies that the slide slow 350 includes images of “User 1.” Additionally, the slide show application 310 also chooses default criteria 1 for an additional slide show 355 to be displayed on the additional digital display device 365. As illustrated in FIG. 3, the default criteria 1 specifies that the additional slide show 355 includes images created at the “specified location.”

The slide show application 310 will then proceed to access the memory/storage device 380 to scan the metadata 340 of images 330 stored on the memory/storage device 380. As noted above, the slide show application 310 will scan the metadata 340 of the images 330 to identify which of the images 330 include “User 1.” In one embodiment, as illustrated in FIG. 3, the slide show application 310 will classify images 1, 3, and 6 as images of interest for the slide show 350, since the slide show application 310 will have determined from the metadata 340 of images 1, 3, and 6 that they include “User 1.” As noted above, in one embodiment, the slide show application 310 can additionally utilize facial recognition technology in conjunction with scanning metadata 340 in determining whether “User 1” is present in the images 330.

Additionally, the slide show application 310 scans the metadata 340 of the images 330 to identify images which were created at the “specified location.” In one embodiment, as illustrated in FIG. 3, the slide show application will classify images 2, 4, and 5 as images of interest since the slide show application 310 will have determined from the metadata 340 of images 2, 4, and 5 that they all were created at the “specified location.”

The slide show application 310 will then create the slide show 350 of the images which include “User 1” and display the slide show 350 of “User 1” on the digital display device 360. As illustrated in FIG. 3, the slide show 350 of “User 1” includes images 1, 3, and 6. Additionally, the slide show application 310 will create the additional slide show 355 of the images which were created at the “specified location” and display the additional slide show 355 of the specified location on the additional digital display device 365. As illustrated in FIG. 3, the additional slide show 355 of the “specified location” includes images 4, 5, and 2.

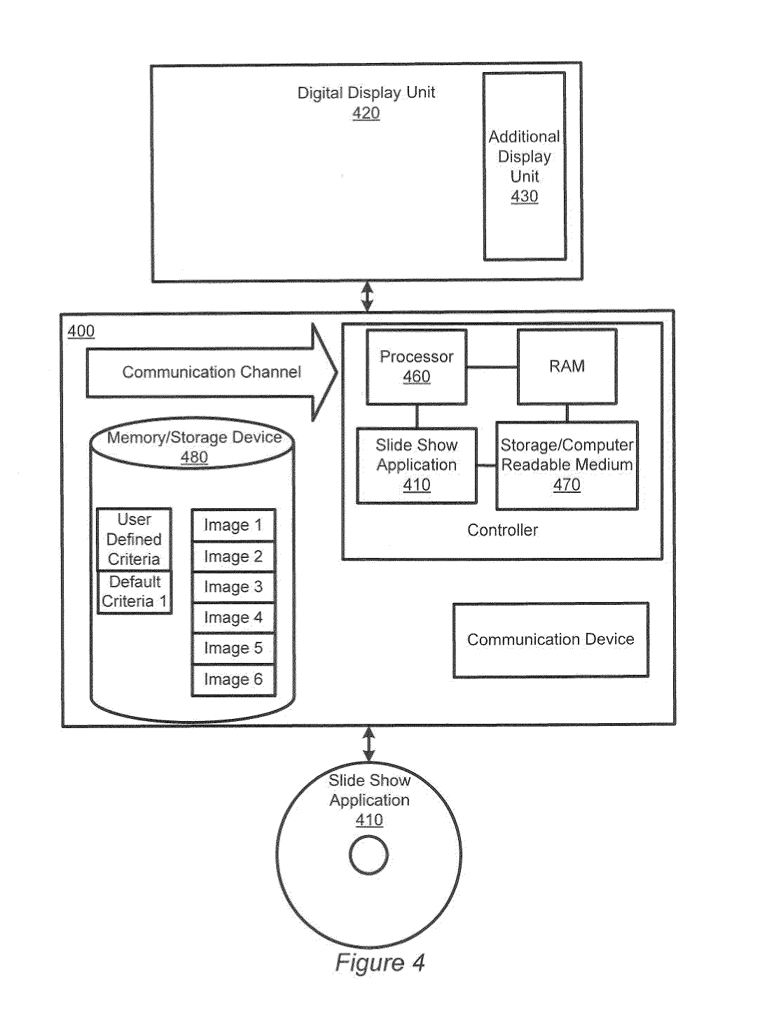

FIG. 4 illustrates a machine with an embedded slide show application 410 and a slide show application 410 stored on a removable medium being accessed by the machine 400 according to an embodiment of the invention. For the purposes of this description, a removable medium is any tangible apparatus that contains, stores, communicates, or transports the application for use by or in connection with the machine 400. As noted above, in one embodiment, the slide show application 410 is firmware that is embedded into one or more components of the machine 400 as ROM. In other embodiments, the slide show application 410 is a software application which is stored and accessed from a hard drive, a compact disc, a flash disk, a network drive or any other form of computer readable medium that is coupled to the machine 400.

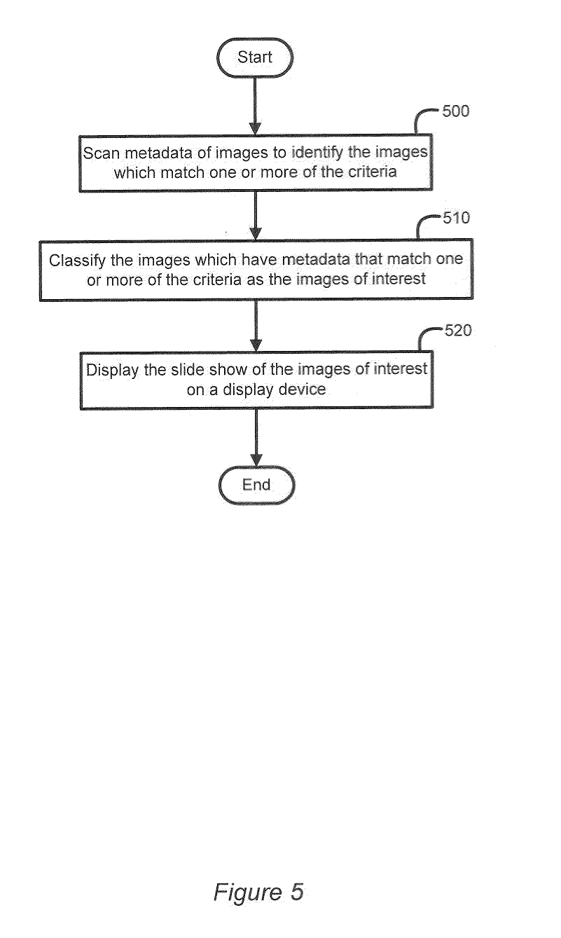

FIG. 5 is a flow chart illustrating a method for displaying images of interest as a slide show according to an embodiment of the invention. The method of FIG. 5 uses a slide show application on a machine, one or more images on a memory/storage device, metadata associated with the images, one or more criteria, and one or more digital display devices. In other embodiments, the method of FIG. 5 uses additional components and/or devices in addition to and/or in lieu of those noted above and illustrated in FIGS. 1, 2, 3, and 4.

As noted above, a slide show application initially identifies one or more criteria to be used for a slide show. One or more criteria are rules for the slide show which determine whether an image will be classified as an image of interest and whether the image will be included in the slide show. In one embodiment, one or more criteria specify that the slide show includes images created on or around a specified date, images created at or around a specified time, images created at or around a specified GPS coordinate (location), images including one or more specified persons, and/or images which do not include any people. In other embodiments, one or more criteria specify additional rules for the slide show.

As noted above, the date of creation and/or time of creation correspond to when the corresponding image was captured or when the corresponding was scanned and/or stored onto the machine. Additionally, as noted above, a GPS coordinate of where a corresponding image was captured or where the corresponding image was scanned and/or stored onto the machine is used as a creation location.

In addition, one or more criteria can be previously defined or upon request. Further, one or more criteria can be defined by a user, downloaded from a webpage, or provided by a manufacturer. Additionally, one or more criteria can be chosen automatically by the machine or manually by a user accessing an input device on the machine or directly accessing the digital display device.

Once the slide show application has identified one or more criteria for the slide show, the slide show application proceeds to scan metadata of images to identify the images which match one or more of the criteria 500. As noted above, all of the images have corresponding metadata. In one embodiment, the metadata specify what date the corresponding image was created, what time the corresponding image was created, at what GPS coordinate (location) the corresponding image was created, who is included in the corresponding image, and whether the corresponding image include any people. As noted above, in another embodiment, the metadata of the images can be defined or edited by a user or the machine. In other embodiments, the metadata specify additional details of the corresponding image.

The slide show application will classify the images which have metadata that match one or more of the criteria as the images of interest 510. As noted above, in one embodiment, if one or more of the criteria specify that the image was created on or around a specified date, created at or around a specified time, and/or created at or around a specified location, the slide show application can additionally utilize a predefined buffer to additionally search for images created within the predefined buffer and classify them as images of interest.

Once the slide show application has finished scanning the metadata of all of the images on the storage device and finished classifying images, with matching metadata, as images of interest, the slide show application will create a slide show of the images of interest. The slide show application will then display the slide show of the images of interest on a digital display device 520.

The method is then complete or the slide show application can scan for one or more users or the machine requesting to create an additional slide show or replace the existing slide show following the method disclosed above. In another embodiment, the slide show and/or the additional slide show can be continued to be displayed one after the other, following a looping process. In other embodiments, the method of FIG. 5 includes additional steps in addition to and/or in lieu of those depicted in FIG. 5.

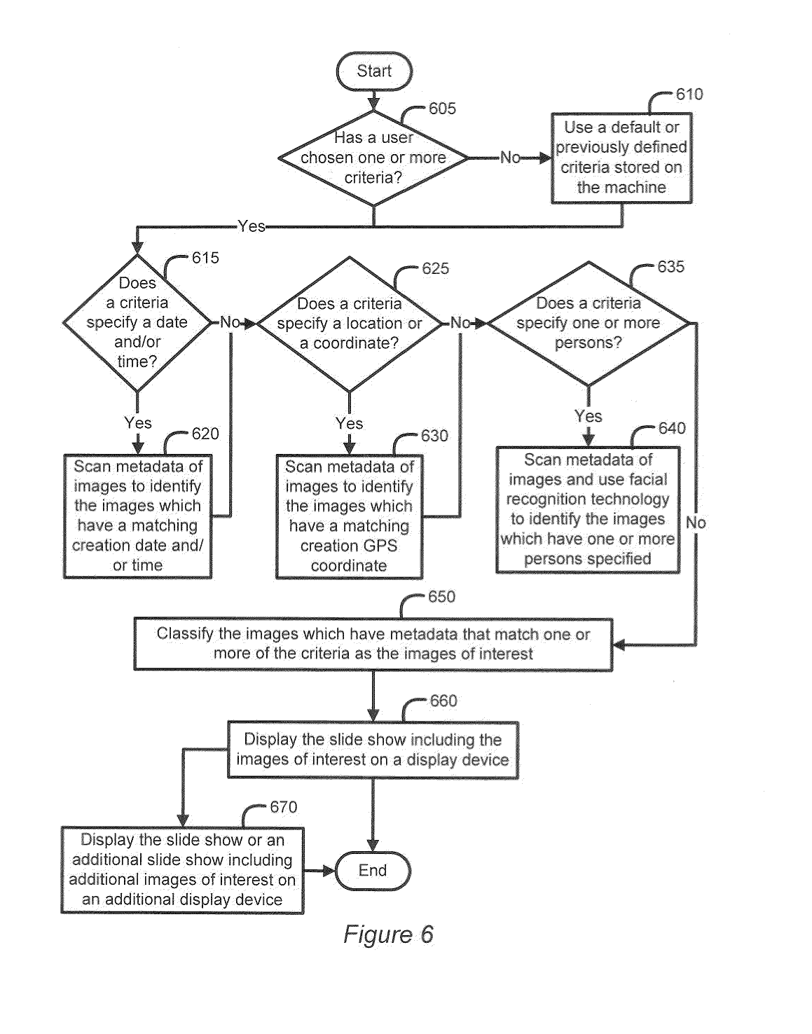

FIG. 6 is a flow chart illustrating a method for displaying images of interest as a slide show according to another embodiment of the invention. Similar to the method of FIG. 5, the method of FIG. 6 uses a slide show application on a machine, one or more images on a memory/storage device, metadata associated with the images, one or more criteria, and one or more digital display devices. In other embodiments, the method of FIG. 6 uses additional components and/or devices in addition to and/or in lieu of those noted above and illustrated in FIGS. 1, 2, 3, and 4.

As noted above, in one embodiment a slide show application will initially determine whether a user has chosen one or more criteria for a slide show to be displayed 605. If a user has not chosen one or more of the criteria, the slide show application will automatically choose one or more default or previously defined criteria stored on the machine 610. As noted above, one or more of the criteria can be manually defined by a user, downloaded from another location, and/or default from a manufacturer. Additionally, the user can choose one or more of the criteria using an input device coupled to the digital display device or by accessing the digital display device if the digital display device includes a touch screen.

The slide show application will then proceed to determine whether one or more of the identified criteria specify a date and/or time 615. If the user has identified one or more criteria for the slide show to be displayed, the slide show application will use one or more of the identified criteria from the user and proceed to determine whether one or more of the identified criteria specify a date and/or time 615. If one or more of the identified criteria do not specify a date and/or time, the slide show application will proceed to determine whether one or more of the identified criteria specify a location or coordinate 625.

If one or more of the identified criteria do specify a date and/or time, the slide show application will initially scan the metadata of all of the images to identify which of the images have a matching creation date and/or time 620 before proceeding to determine whether one or more of the identified criteria specify a location or coordinate 625. As noted above, the date of creation and/or the time of creation correspond to when the corresponding image was captured or when the corresponding was scanned and/or stored onto the machine. Additionally, as noted above, a GPS coordinate of where a corresponding image was captured or where the corresponding image was scanned and/or stored onto the machine is used as a creation location.

If one or more of the identified criteria do not specify a location or coordinate, the slide show application will proceed to determine whether one or more of the identified criteria specify one or more persons to be included in the slide show 635. If one or more of the identified criteria do specify a location or time, the slide show application will initially scan the metadata of all of the images to identify which of the images have a matching GPS coordinate 630 (creation location) before proceeding to determine whether one or more of the identified criteria specify one or more persons to be included in the slow show 635.

If one or more of the identified criteria do not specify one or more persons to be included in the slide show, the slide show application will proceed to classify the images which have metadata that match one or more of the identified criteria as images of interest 650. If one or more of the identified criteria specify one or more persons to be included in the slide show, the slide show application will initially scan metadata of images and use facial recognition technology in conjunction with scanning the metadata to identify the images which include one or more persons specified 640 before proceeding to classify the images which have metadata that match one or more of the identified criteria as images of interest 650.

As noted above, in one embodiment, one of more of the identified criteria can also specify for the slide show to include images which do not include any people. As a result, the slide show application will scan the metadata of all of the images to determine whether the images include any people. Additionally, as noted above, the slide show application can use face detection technology in conjunction with scanning the metadata to determine which of the images do not include any people.

Once the slide show application has classified all of the images of interest, the slide show application will proceed to display the slide show including the images of interest on a display device 660. In other embodiments, the slide show application can additionally display the slide show or an additional slide show including additional images of interest on an additional display device 670. The slide show application can create the additional slide show concurrently while creating the slide show.

The method is then complete or the slide show application can continue to scan for one or more users or the machine requesting to create an additional slide show or replace the existing slide show following the method disclosed above. In another embodiment, the slide show and/or the additional slide show can be continued to be displayed one after the other, following a looping process. In other embodiments, the method of FIG. 6 includes additional steps in addition to and/or in lieu of those depicted in FIG. 6.

By scanning metadata of images to identify which images can be classified as images of interest, a personalized slide show can be created for one or more users. Additionally, by creating the slide show based upon one or more criteria, the users can view memorable images that are meaningful and significant to the users in their personalized slide shows. Further, by utilizing one or more additional display devices, additional slide shows based upon additional criteria can be displayed for one or more users.

What is claimed is:

1. A method for displaying images of interest as a slide show comprising:
scanning metadata of images to identify the images which match one or more criteria;
classifying the images which have metadata that match one or more of the criteria as the images of interest; and
displaying the slide show of the images of interest on a display device.

2. The method for displaying images of interest as a slide show of claim 1 wherein one or more of the criteria are previously defined by a user.

3. The method for displaying images of interest as a slide show of claim 1 wherein one or more of the criteria are randomly chosen from one or more previously defined criteria available on a machine.

4. The method for displaying images of interest as a slide show of claim 1 wherein one or more of the criteria specify that the images of interest are images created on a specified date.

5. The method for displaying images of interest as a slide show of claim 1 wherein one or more of the criteria specify that the images of interest are images created at a specified time.

6. The method for displaying images of interest as a slide show of claim 1 wherein one or more of the criteria specify that the images of interest are images created at a specified location.

7. The method for displaying images of interest as a slide show of claim 1 wherein one or more of the criteria specify that the images of interest are images of one or more specified persons.

8. The method for displaying images of interest as a slide show of claim 1 wherein one or more of the criteria specify that the images of interest are images which do not include any people.

9. The method for displaying images of interest as a slide show of claim 1 wherein the metadata of the images specify at least one from the group consisting of a date of creation for a corresponding image, a time of creation for the corresponding image, a GPS coordinate of where the corresponding image was created, and whether one or more persons are included in the corresponding image.

10. A computer-readable program in a computer-readable medium comprising:
a slide show application configured to scan metadata of images and classify images with metadata that match one or more criteria as images of interest; and
additionally wherein the slide show application is configured to create a slide show of the images of interest and display the slide show on a display device.

11. A computer-readable program in a computer-readable medium of claim 10 wherein the slide show application is further configured to scan the metadata of images for a specified date or a specified time that matches one or more of the criteria.

12. A computer-readable program in a computer-readable medium of claim 11 wherein the slide show application is further configured to classify the images whose metadata include a date or a time that is within a predefined buffer away from the specified date or the specified time as the images of interest.

13. A computer-readable program in a computer-readable medium of claim 10 wherein the slide show application is further configured to scan the metadata of images for a specified GPS coordinate that matches one or more of the criteria.

14. A computer-readable program in a computer-readable medium of claim 13 wherein the slide show application is further configured to classify the images whose metadata include a GPS coordinate within a predefined distance away from the specified GPS coordinate as the images of interest.

15. A computer-readable program in a computer-readable medium of claim 9 wherein the slide show application is further configured to scan the metadata of images for one or more persons that match one or more of the criteria.

16. A computer-readable program in a computer-readable medium of claim 15 wherein the slide show application is further configured to use facial recognition technology when scanning the images for one of more of the persons.

17. A computer-readable program in a computer-readable medium of claim 15 wherein the slide show application is further configured to use face detection technology when determining whether the images include any people.

18. A machine comprising:
a processor;
a display device configured to display a slide show;
at least one storage device coupled to the machine and configured to store images;
a slide show application stored on computer readable memory and executed by the processor to scan metadata of the images to identify the images that match a criteria and including the images that match the criteria as images of interest to be displayed as the slide show.

19. The machine of claim 18 further wherein at least one storage device is separate from the machine and is remotely accessed by the slide show application.

20. The machine of claim 18 further comprising an additional display device configured to display the slide show or an additional slide show including additional images of interest.
